(19) United States
(12) Patent Application Publication
(10) Pub. No.: US 2012/0122494 A1
(43) Pub. Date: May 17, 2012

(54) METHOD FOR CO-LOCATION OF CALLER AND RECEIVER DURING A CALL ON A CELLULAR OR WIRELESS NETWORK

(76) Inventor: Ran Cohen, Tel Aviv (IL)

(21) Appl. No.: 12/945,919

(22) Filed: Nov. 15, 2010

(51) Int. Cl. H04W 4/02

(52) U.S. Cl. 455/457

(57) ABSTRACT

The present invention provides a method to enable a “caller,” while calling at least one call “receiver”, on a handheld device, or any communication device, to communicate the physical location of the caller and receiver, at a given moment. The method comprises: the caller calling at least one receiver; the caller sending each of the at least one receiver a request to authorize to see the other parties location on the map; receiving an approval; and showing the location of the at least one receiver as well as the caller on a digital map on the screens of the caller and said at least one receiver.

### FIELD OF THE INVENTION

The present invention relates generally to mobile telephony, and more particularly, to a method and a system for co-location of caller and receiver during a call on a cellular or wireless network (“see me see you”).

### BACKGROUND OF THE INVENTION

Location-based services are well-known in the art. See the following links:
http://sfl.sprintpcs.com/finder-sprint-family/moreInfo.htm
http://www.childlocate.co.uk/productmain.html
www.ibm.com/developerworks/ibm/library/i-lbs/
www.cio.com/article/603920/Facebook_s_{—}4_Big_Rivals_in_Location_Based_Technology
http://pr-canada.net/index.php?option=com_content&task=view&id=253349&Itemid=58
http://techcrunch.com/2010/10/07/dodgeball-patent-facebook/

More specifically, providing location during a mobile call or other call is also known:

U.S. Pat. No.7,593,740, Location-Based Social Software for Mobile Devices, by Crowley and Rainert, teaches a method of establishing connection between users of mobile devices includes receiving at a computer a location of a first user from a first mobile device, receiving from a second mobile device a location of a second user having an acquaintance relationship to the first user, and sending a message to the first mobile device based on the proximity of the first user to the second user.

This patent involves neither a phone call, authorization on the other side nor routing for a meeting, but it is an milestone in the art.

U.S. Pat. Applic. No. 20070117571, by Musial, describes user location retrieval for consumer electronic devices. The invention relates to providing user data to recommender systems of consumer electronic devices and, more particularly, to providing locations of the user's mobile terminal to such systems. The invention furnishes information about the past location of a mobile terminal of the user. The recommender may then propose content related to the past location.

The invention is based on the observation that the user's mobile terminal, such as a mobile phone, hand-held global positioning system (GPS) receiver, personal digital assistant (PDA), has evolved into a strictly personal device that the user almost always carries with him and that the mobile phone, for example, is able to retrieve location information on different gradation levels. Broadcasted control information in a mobile terminal network such as a mobile phone network includes data that identifies the country and the base station or base transceiver station (BTS) making the broadcast. It can thus be determined, for example, from the data that the mobile phone was in Spain and within the broadcast coverage area of a BTS in Barcelona.

The invention is also based on the observation that the mobile phone can retrieve this information automatically, and can convey it automatically to the recommender by means of the Bluetooth ad hoc network which is being integrated more and more into mobile and home CE devices. In brief, the invention determines its current location, saves an identifier of the determined location, and informs the recommender system of the determined location.

U.S. Pat. Applic. No. 20060230137, by Gare, et al, provide a Location or Activity

Monitor, which enables a Providing Member to supply visibility in real-time to Requesting Members of their current location or activity, a literal or abstract description of their current location, the communications services available to them at their current location, and their willingness and ability to communicate. The presented Location or Activity information may be personalized depending upon a Member Group assigned by the Providing Member to the

Requesting Member. Requesting Members who submit an enquiry for current Location or Activity information relating to a particular Providing Member will see the personalized Location or Activity information for the Providing Member's current location.

U.S. Pat. Applic. No. 20080318592, by Mandalia, Delivering Telephony Communications to Devices Proximate to a Recipient After Automatically Determining the Recipient's Location, discloses a communication method and system, which can include a step of repetitively conveying presence information to a service provider to continuously update a current location of a person identified within the presence information. A communication attempt directed towards the person can be detected. A communication device proximate to the person can be determined based upon the presence information.

The communication device can be accessible by any proximate individual. The communication device can be one not specifically designated by an originator of the communication attempt. A notification of the communication attempt can be presented in an environment proximate to the determined communication device. The communication can be established responsive to the person answering the notification by activating the communication device.

U.S. Pat. Applic. No. 20040192346, by Chang, et al, teach a location capable mobile handset. Briefly, the location capable mobile handset allows the user to provide a call recipient with the location of an unsuccessful attempted emergency call. In one specific example, the call may be an E911 call to a PSAP dispatcher, however, it will be appreciated that the call may be to request assistance from a family member, or friend. Additionally, the call may be to a towing service. The call could be any call that a mobile handset user wants to send location information to the party that has been called.

Returning to the E911 call, for example, the location information reported to dispatcher can include the location of the initial E911 call, current location during a successful E911 call, or ground track information from the initial location to the current location. When an E911 call is unsuccessfully attempted the mobile handset stores the location of the mobile handset at that time. This information can later be transmitted when the mobile handset is in a coverage area. Additionally, the mobile handset can auto-dial 911 upon entering a service area after an unsuccessful E911 attempt. Alternately the user can be prompted to initiate an E911 call when the mobile handset enters a service area.

Thus, it would be advantageous to the art of telephony to enable a cellular or wireless network caller and call recipient to have the option of viewing each other's location.

### SUMMARY OF THE INVENTION

Accordingly, it is a principal object of the present invention to enable a cellular or wireless network caller and call recipient to have the option of viewing each other's location.

It is another principal object of the present invention to enable a cellular or wireless network caller and call recipient to have the option of viewing each other's location on a GPS derived map on a screen of their respective handsets.

It is yet another principal object of the present invention to enable a cellular or wireless network caller and call recipient to have the option of viewing each other's location.

When 2 users are talking on wireless networks (cellular , wireless WAN or any new wireless network), a common question is “Where are You” with or without the intention of the user to meet. The invention allows the user, while making the call, to ask the other party for his/her location, by clicking on a request button, thus not breaking privacy rules, and once the other party authorizes the request, the 2 parties can see on the screen of their handsets or PCs the location of each other on a map. They can use this information to meet or They can determine a meeting point on the map, and the system will guide each of one them independently to the meeting point.

The invention also allows for users to pre-authorize other users to see their location, thus, for example, parents, can find the location of their children without calling them.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

For a better understanding of the invention with regard to the embodiments thereof, reference is now made to the accompanying drawings, in which like numerals designate corresponding elements or sections throughout, and in which:

FIG. 1 is an exemplary schematic illustration of the handset screens of the caller and one call receiver, showing exemplary button configurations, constructed in accordance with the principles of a preferred embodiment of the present invention;

FIG. 2 is an exemplary schematic illustration of the handset screens of the caller and one call receiver, showing initial map configurations, constructed in accordance with the principles of a preferred embodiment of the present invention;

FIG. 3 is an exemplary schematic illustration of the handset screens of the caller and one call receiver, showing progressed map configurations, constructed in accordance with the principles of a preferred embodiment of the present invention;

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

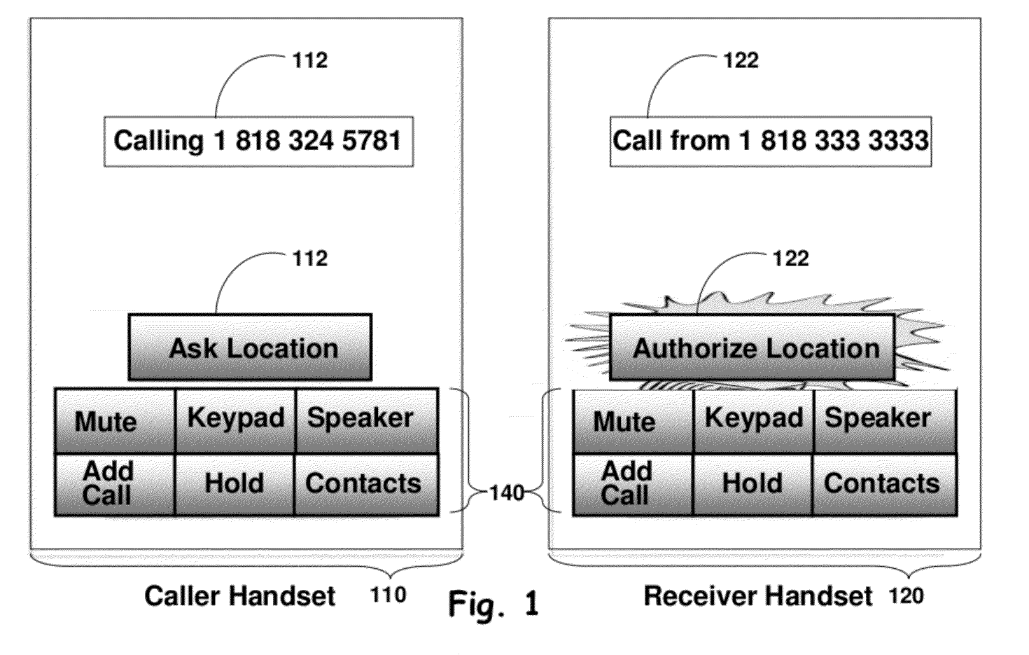

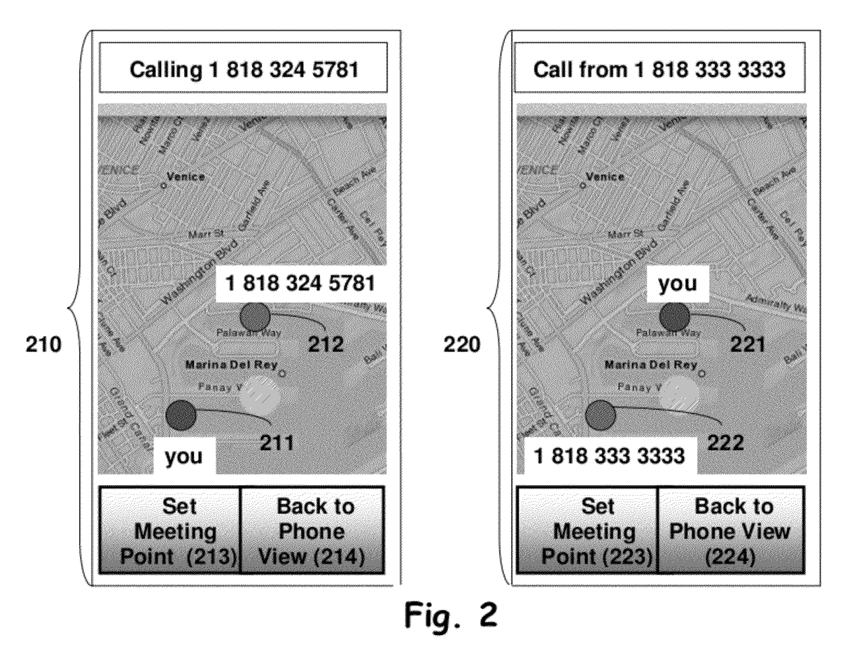

FIG. 1 is an exemplary schematic illustration of the handset screens of the caller 110 and one call receiver 120, showing exemplary button configurations, constructed in accordance with the principles of a preferred embodiment of the present invention. The number called 111 and the number called from 121 are shown in respective windows of the handset screens. Caller screen 110 also has a button whereby the caller can Ask Location 112 from the call receiver. Subsequently, in an exemplary embodiment the Authorize Location button 122 of call receiver's handset 120 will flash. The call receiver can optionally click Authorize Location button 122 and the view of FIG. 2 described below will appear on the respective handsets. Other standard handset buttons 140 are also shown on both handset 110 and handset 120.

FIG. 2 is an exemplary schematic illustration of the handset screens of the caller 210 and one call receiver 220, showing initial map configurations, constructed in accordance with the principles of a preferred embodiment of the present invention. Caller 211 on caller handset 210 sees his own location, as well as the location of the called number 212.

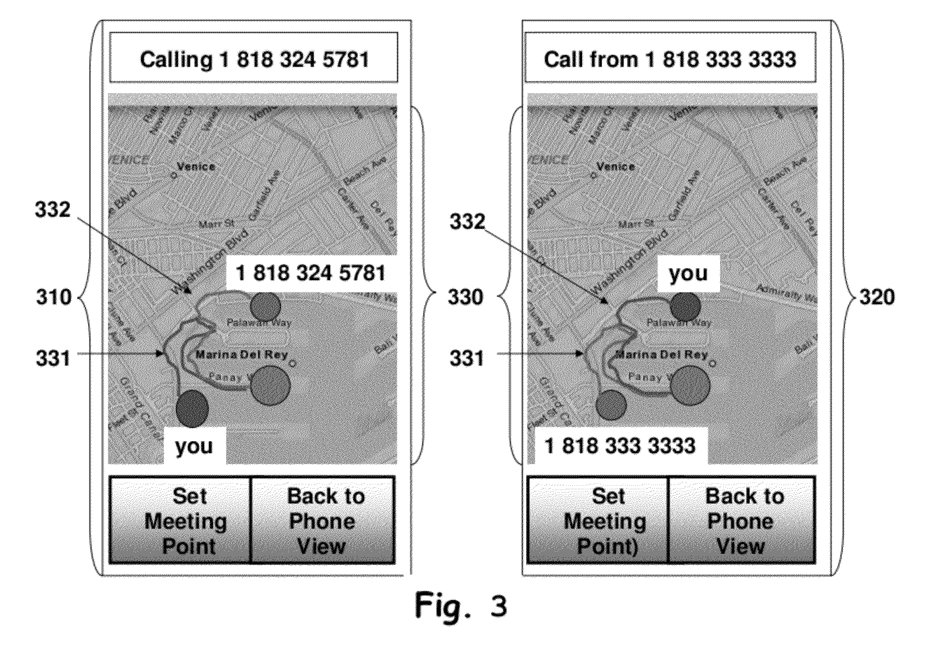

Receiver 221 on receiver handset 220 sees his own location, as well as the location of the calling number 222. In an exemplary embodiment, when the parties verbally agree on where to meet, either one or both parties can click Set Meeting Point 213 or 223 and begin to “map” their routes, as described below with respect to FIG. 3 described below. At any time either party can click Back to Phone View 214 or 224.

FIG. 3 is an exemplary schematic illustration of the handset screens of the caller 310 and one call receiver 320, showing progressed map configurations 330, constructed in accordance with the principles of a preferred embodiment of the present invention. The proposed routes of the caller 331 and the receiver 332 are shown.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. A method to enable “caller,” while calling at least one call “receiver”, on a handheld device, or any communication device, said method comprising:
said caller calling said at least one receiver;
said caller sending each of said at least one receiver a request to authorize to see the other parties location on the map
receiving an approval; and
showing the location of said at least one receiver as well as the caller on a digital map on the screens of the caller and said at least one receiver.

2. The method of claim 1, further comprising determining a meeting point on said map by said caller and/or said at least one receiver, and said meeting point appearing on the other party's screen.

3. The method of claim 2, further comprising calculating and mapping the route for each call and displaying the mapped route on the respective screens.

4. The method of claim 3, further comprising determining such meeting point automatically by the system as either the most convenient or fastest/shortest routes for meeting.

5. The method of claim 1, further comprising “applying” authorization once and allowing automatic co-location whenever these 2 parties call

6. The method of claim 5, wherein said at least one receiver does not have to answer his/her phone, and thereby further comprising returning the location without the call having been completed.

7. The method of claim 1, wherein at least one of the caller and at least one of said receivers are on a non-wireless network, but are connected to a PC or a screen that can request their permission to see the other who is on a wireless network.
